(19) United States
(12) Patent Application Publication
(10) Pub. No.: US 2002/0006038 A1
(43) Pub. Date: Jan. 17, 2002

(54) Device for attachment to a flashlight

(76) Inventor: Peter Fladung, Varel (DE)

Correspondence Address: COLLARD & ROE, P.C., 1077 Northern Boulevard, Roslyn, NY, 11576, US

(21) Appl. No.: 09/902,952

(22) Filed: Jul. 11, 2001

(30) Foreign Application Priority Data
Jul. 13, 2000 (DE) 100 34 115.2
Sep. 28, 2000 (DE) 200 17 011

(51) Int. Cl. F21L 2/00; B26D 11/00

(52) U.S. Cl. 362/157; 83/862

(57) ABSTRACT

A device for coupling to a battery operated flashlight comprising a window breaking implement, and a cutting implement, which can be a cap for covering the battery compartment of the flashlight. A thread can be provided for screw-type attachment to the flashlight and wherein said window breaking implement is arranged on a surface of the device which faces the surface provided for attachment to the flashlight. The window breaking implement can be centrally located in the device or cap and includes a striking pin at one end to break glass. The cutting implement consists of one or more blades located in a narrow recess in the device so as to cut seat belts or other thin fabric materials. Thus, the device can be provided to emergency personnel for use in car accidents to help evacuate passengers.

### BACKGROUND OF THE INVENTION

### CROSS REFERENCE TO RELATED APPLICATIONS

Applicant claims priority under 35 U.S.C. §119 of German Application Nos. 100 34 115.2 and 200 17 011 filed Jul. 13, 2000 and Sep. 28, 2000, respectively.

1. Field of the Invention

This invention relates to a device, in particular for attachment to a flashlight.

Flashlights are known in a multitude of different designs. In particular, stronger flashlights which are mostly a rounded elongated battery shaft containing batteries, and at the same time serves as the handle, are often carried by members of security systems on duty, to check and control persons and objects in the dark.

2. The Prior Art

In German utility model DE 298 19 570 U1, there is shown German utility model DE 297 17 194 U1, and from DE 40 41 401 A1.

### SUMMARY OF THE INVENTION

It is an object of the present invention to provide a device for attachment to flashlights comprising a battery shaft which also serves as a handle, and is designed so as to be particularly flexible and versatile in use. In the invention, the device comprises a window breaking implement, and furthermore a cutting implement. In this way, a multipurpose flashlight can be provided which is very suitable for use by security services. With this flashlight, a window breaking implement which is preferably arranged at the end of the flashlight pointing away from the incandescent bulb, allows windows and in particular car windows or windscreens to be broken. Moreover, with the cutting implement, bolts or webbing, such as motor vehicle seatbelts, can be cut. This device thus creates a universally usable tool.

Preferably, the invention tool is designed as a cap for a battery compartment of the flashlight. In principle however, its use as a standalone device or in conjunction with, or as a supplement to, other devices such as for example radio sets, is also possible. Advantageously, the device has a thread for screw-on attachment to a flashlight so that it not only forms a cap for closing the battery compartment, but also includes a window breaking implement and a belt cutter. Preferably, the window breaking implement is arranged on the side of the device which faces the side provided for attachment to the flashlight, so that the bulb does not get damaged when the window breaking implement is used, and so that both the incandescent bulb and the window breaking implement can easily be operated via the battery compartment, which at the same time, serves as a handle. Advantageously, the window breaking implement is a point made of hard metal, or a point made of ceramics, making it possible during rescue measures to quickly destroy windows or windscreens, such as safety glass or laminated glass. The window breaking implement is centrally located on the outside of the device. In a preferred embodiment of the invention, the device comprises a centrally arranged pin or striking pin whose one extremity directly adjoins the window breaking implement, and whose other extremity extends beyond the device. When the device is attached to a flashlight, this pin protrudes into the battery compartment of the flashlight and extends into the flashlight. The pin is preferably screwed to the window breaking implement, and able to be moved to and fro, in a central recess of the device. When the window breaking implement is used, the effect of the kinetic energy of the batteries during impact, is transferred to the striking pin of the implement, thus causing an additional pulse. In order to prevent the window breaking implement together with the striking pin, from sliding outward beyond the device during normal use, in addition a stabiliser is provided with the striking pin. This stabiliser is preferably a spring and holds the striking pin inserted into the device in its position. The stabiliser, and in particular the spring are thus provided on the extremity of the device pointing away from the implement, at the striking pin. The striking pin is spring loaded towards the batteries so that the pin protrudes towards the batteries. During impact of the batteries onto the pin, said pin is pushed in the direction towards the device, against the slight force of the stabiliser. In this way, the window breaking implement at the other extremity of the pin, impacts upon the glass pane to be destroyed. As an alternative, the stabiliser can also be a radial packing or a rubber ring. Other elastic elements which provide pre-tensioning of the pin, are also imaginable.

In another embodiment of the invention, the cutting implement is arranged in an annular recess of the device. The recess is a circumferential gap or is annular, and aligned perpendicular to the point of the window breaking implement. When viewed from the window breaking implement, this recess is arranged in the direction towards the flashlight so that the window breaking implement is always freely accessible. Preferably, the recess in which the cutting implement is arranged, is narrower than the width of a finger, so that there is no possibility of injury as a result of the cutting implement. In any case, the width of the recess is such that a seat belt which is intended to be cut by the cutting implement, can be inserted. Preferably, the recess is a gap, approximately 3 mm in width. The cutting implement is arranged in the recess at a distance to the external dimensions of the device, so that no injuries can occur during handling of the flashlight. Preferably the cutting implement comprises two blades pointing outwards so that the belt to be cut, or any other item to be cut can be fed from different directions. The blades are arranged along the entire height of the recess, preferably at an oblique angle, so that a particularly safe and simple cut can be made. The cutting implement can also be only one blade, or three, or several blades. The device can be a shaped mark corresponding to the direction of the blade, for example a depression, a projection or a recess. In this way, the operator can feel in the dark the direction of alignment of te blade, and therefore the direction in which an item to be cut must be fed to the cutting implement. In principle, fluorescent colour markings or other markings can also be provided but it has been shown that shaped marks are particularly reliably recognisable even in the dark.

In another embodiment of the invention, a guide is arranged in the recess, being approximately wedge-shaped, to ensure even better access to the blade of the cutting implement, of the narrow edge of a seatbelt. This allows particularly fast and reliable cutting of a seat belt. In a preferred embodiment, the underside of an upper part of the device is tapered in a cone shape so that the guide is arranged around the entire circumference of the recess.

Furthermore, the invention relates to a flashlight which comes with a device of the type described above. Thus the invention which discloses a complete rescue device approximately with the dimensions of a flashlight which security personnel would be carrying anyway, relates not only to a device for retrofitting to existing flashlights, but it also relates to flashlights which already incorporate this device.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a cross-sectional view of a device according to the invention arranged on a flashlight;

FIG. 2 is an exploded lateral view of the device according to the invention;

FIG. 3 is a view of an upper part of the device according to the invention;

FIG. 4 is a view of a lower region of the device according to the invention; and

FIG. 5 is a cross-sectional view of a second embodiment of a device according to the invention.

### DETAILED DESCRIPTION OF PREFERRED EMBODIMENTS

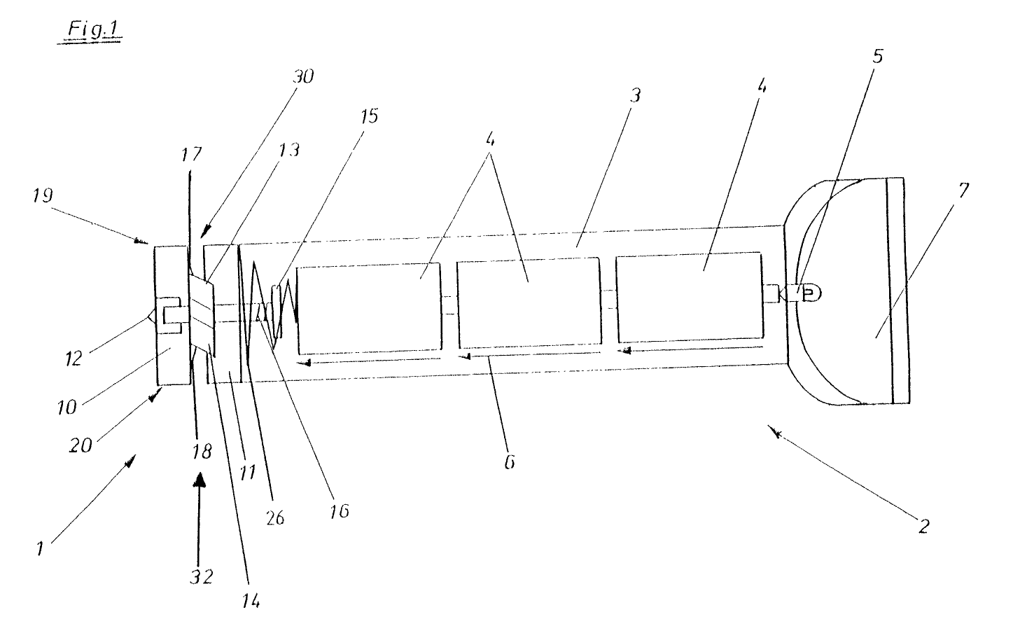

Referring to FIG. 1, there is shown a cross-sectional view of a device 1 according to the invention, arranged at the end of the battery compartment 3 of a flashlight 2. On its right extremity, flashlight 2 comprises a reflector 7 with an incandescent bulb 5 centrally arranged therein. Incandescent bulb 5 derives its power from three batteries 4, located in battery compartment 3 of flashlight 2. Battery compartment 3 at the same time serves as the handle of flashlight 2. On the left end of flashlight 2, is screwed on a removable cap, so that batteries 4 in battery compartment 3 can be changed. The cap has an electrical contact in the form of a spring 26, in contact with batteries 4. This cap is replaced by device 1 which has a thread by which it can be screwed onto flashlight 2. At its end facing the thread, the device is configured so that its end is suitable for accommodating spring 26. In particular, device 1 is designed to correspond to the cap of flashlight 2. On its end opposite reflector 7, device 1 comprises a window breaking implement 12, such as a pointed projection made of hard metal or ceramic material. Point 12 is suitable for destroying safety or laminated glass, in particular motor vehicle windows or windscreens. Window breaking implement 12 is arranged on an upper part 10 of device 1. Adjacent to upper part 10, there is provided a lower part 11. Upper part 10 and lower part 11 are separated from each other to define a gap-like recess 30. A cutting implement 32 is disposed in recess 30, and serves as a belt knife. Cutting implement 32 has two blades 13 and 14 which are recessed from the outer dimensions of device 1, so that device 1 can be safely handled without the cutting implement posing any danger of injury. In addition, the recess 30 is sufficiently narrow to prevent a human finger from contacting cutting implement 32. Recess 30 is however wide enough for a seat belt to be inserted into recess 30. In recess 30, in particular in the lower region of the upper part 10, wedge-shaped belt guides 17 and 18 are provided to reliably guide the belt onto blades 13 and 14. In addition, shaped marks 19 and 20, designed as tactile depressions are formed on upper part 10, with the position of shaped marks 19 and 20 corresponding to the alignment of blades 13 and 14. Upper part 10 and lower part 11 are interconnected by a central region in which a striking pin 15 is disposed. Pin 15 is stabilised by a stabiliser 16 such as a spring, so that during normal handling of flashlight 2 window breaking implement 12, connected to the striking pin 15, cannot protrude or rattle. Protruding beyond striking pin 15, a spring 26 is provided on the device to establish the electrical contact with batteries 4, and to retain batteries 4 in a defined position. If a pane of glass is to be broken or destroyed in one blow, then when window breaking implement 12 impacts upon the pane of glass, batteries 4, due to their kinetic energy, move in the direction of arrows 6 where their considerable weight strikes pin 15 so that an additional pulse acts on the pane of glass via the window breaking implement 12, thus reliably destroying the pane of glass. Apart from the comparatively slight force of the stabiliser 16, striking pin 15 is freely movable so that the kinetic energy of the batteries is almost entirely transmitted to window breaking implement 12.

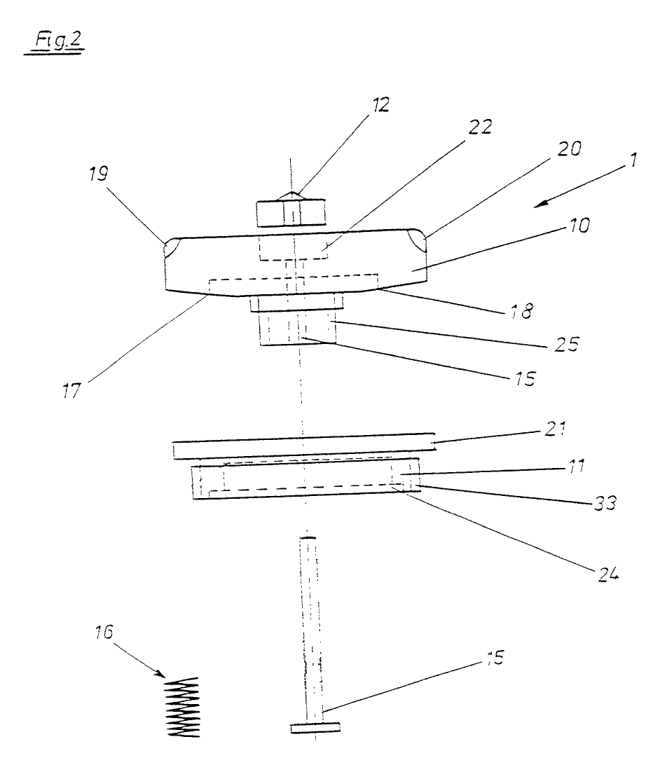

FIG. 2 shows an exploded view of the device 1. Window breaking implement 12 can be inserted into a recess 22 formed in upper part 10. Upper part 10 is approximately cone-shaped so that from all directions there is a wedge-shaped incline which serves as a belt guide 17, 18. On upper part 10, a spacer or bushing 25 is provided which ensures a gap between upper part 10 and the lower part 11 or a blade retainer 21. The gap corresponds to the size of cutting implement 32. Spacer 25 is firmly arranged on upper part 10 and passes through corresponding recesses in blade retainer 21 and lower part 11 where it is screwed into place, so that spacer 25 overall ensures that upper part 10, blade retainer 21 and lower part 11 are firmly held together. Striking pin 15 extends through spacer 25, with pin 15 extending through the entire device 1. For embodiments which do not incorporate a striking pin, a screw of a length appropriate to the device is used, inserted from the bottom through the spacer, with window breaking implement 12 then being firmly positioned on upper part 10 of device 1, by means of this screw. Blade retainer 21 is placed onto the lower end of spacer 25. Blade retainer 21 has two recesses arranged parallel to each other, as is the case with upper part 10, with the blades being insertable into the recesses. In addition, lower part 11 has a thread formed on its exterior margin 33, so that device 1 can be screwed onto a flashlight. In addition, in the lower end of the lower part 11, a circumferential groove 24 is provided into which an annular seal can be inserted. Groove 24 is provided in lower part 11 so that the housing of the flashlight to be screwed on, contacts this groove and circumferential groove 24 and the annular seal accommodated therein, to ensure that the battery compartment of the flashlight is tightly sealed. Spring 16 is placed onto striking pin 15 whose lower extremity protrudes from device 1, as shown in FIG. 1. In this way, window breaking implement 12 is held onto upper part 10 of the device.

FIG. 3 shows a bottom view of FIG. 2, of the upper part 10, with blades 13 and 14 disposed in corresponding recesses in upper part 10. They are arranged parallel and offset in relation to each other so that if in FIG. 3 a belt is inserted from the left, blade 14 will cut this belt. Blades 13 and 14 are spaced away from the geometric centre of the device to allow room for spacer 25 and striking pin 15 centrally located therein. On their side facing outward, the blades are slightly inclined, as shown in FIGS. 1 and 5. On the other side, blades 13 and 14 are straight, i.e. they pass right through from top to bottom in recess 30. In this way, unintentional catching of the belt in this region is largely avoided. A tactile depression 19 is arranged on the sharp side of blade 14, the sharp side pointing outward. Thus, guided by tactile depression 19, the operator can establish even in the dark, that blade 14 is positioned directly adjacent to this tactile depression 19. However, the blade 14 is, in any case, recessed from the outer margin of upper part 10, so that no unintentional injuries can occur. The same applies to second blade 13 which in FIG. 3 cuts belts or ropes which are fed in from the right. The blades can, for example, be the type of blade used in carpet knives.

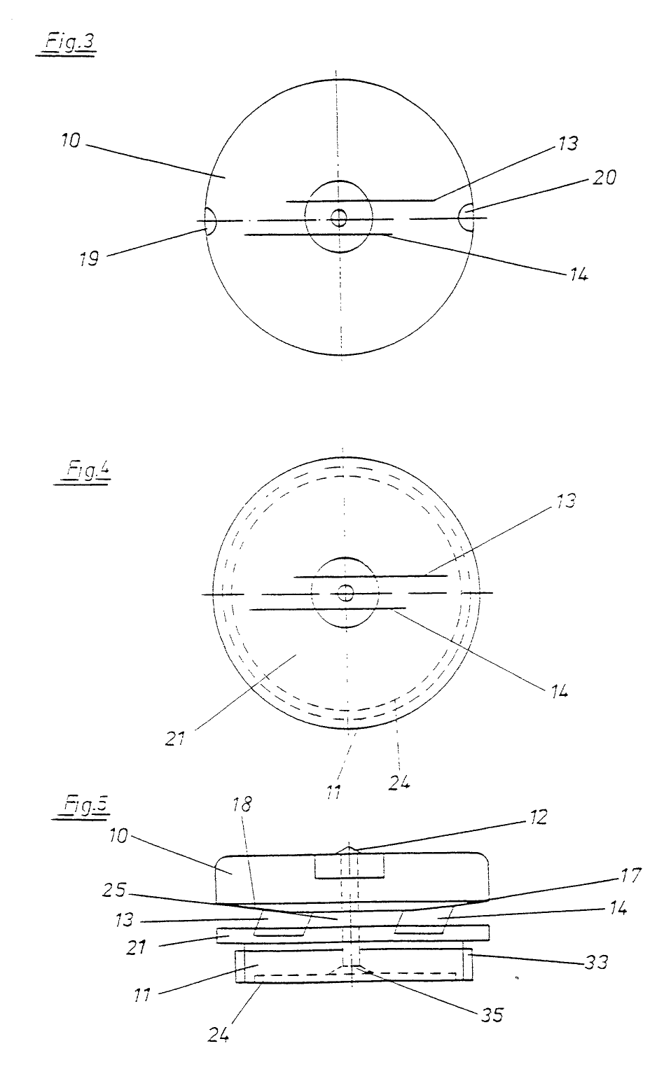

FIG. 4 shows a view of the lower region, in particular blade retainers 21. Recesses corresponding to the recesses in upper part 10 are provided, so that the blades 13 and 14 in the upper part 10 are reliably held in blade retainer 21 in mutually corresponding recesses. The dashed lines indicate the further components situated underneath blade retainer 21. This includes lower part 11 as well as circumferential recess 24 for accommodating an annular seal, the circumferential recess 24 being provided in lower part 11.

FIG. 5 shows a cross-sectional view of a second embodiment of the invention. This embodiment differs from the previously shown embodiment in that there is no striking pin, and that in upper part 10, blade retainer 21 and lower part 11 are essentially held together by a screw 35 wherein the entire unit is installed. Blades 13 and 14 protrude into respective recesses of blade retainer 21 so that blades 13 are safely held.

Accordingly, while only two embodiments of the present invention have been shown and described, it is to be understood that many changes and modifications may be made thereunto without departing from the spirit and scope of the invention as defined in the appended claims.

What is claimed is:

1. A device for coupling to a battery operated flashlight comprising:
a window breaking implement, and
a cutting implement.

2. The device according to claim 1 comprising a cap for covering the battery compartment of the flashlight and housing said window breaking implement and a cutting implement.

3. The device according to claim 1 comprising a thread for screw-type attachment to the flashlight.

4. The device according to claim 1 wherein said window breaking implement is arranged on a surface of the device which faces the surface provided for attachment to the flashlight.

5. The device according to claim 1 wherein said window breaking implement comprises a point made of hard metal.

6. The device according to claim 2 wherein said window breaking implement is centered on the outside of said cap.

7. The device according to claim 1 wherein said window breaking implement comprises at one end, a striking pin, centrally disposed in the device, coupled to one end thereof, and having its opposite end extending into the battery compartment of the flashlight.

8. The device according to claim 1 comprising a stabiliser coupled to said striking pin.

9. The device according to claim 1 comprising a recess, and a cutting implement disposed in said recess.

10. The device according to claim 9 wherein said cutting implement is disposed in said recess and spaced apart from the external dimensions of the device.

11. The device according to claim 9 wherein said recess is narrower than the width of a finger.

12. The device according to claim 9 comprising a guide disposed in said recess.

13. The device according to claim 1 wherein said cutting implement comprises two blades directed outwardly.

14. The device according to claim 13 comprising a shaped mark formed on the device which corresponds to the direction of said blades.

15. A flashlight having a battery compartment for receiving batteries comprising:
a cap coupled to the battery compartment,
a window breaking implement slidably disposed in said cap, and having one end extending into the battery compartment of the flashlight for contact with the batteries,
a spring urging said breaking implement against the batteries,
a striking pin formed at the other end of said window breaking implement for protrusion out of said cap, so that when said cap is struck against a window surface, the kinetic energy of the batteries in motion overcomes the spring force and moves the breaking implement and striking pin to protrude out of said cap and impact the window surface.

16. A device for attachment to a battery operated flashlight, having a battery compartment comprising:
a breaking implement, and
a striking pin formed at one end of said window breaking implement, said striking pin having its other end extending into the battery compartment of the flashlight.

17. The device according to claim 16 wherein the device comprises a cap for coupling to the battery compartment of the flashlight.

18. The device according to claim 16 comprising a thread for screw-type attachment to the flashlight.

19. The device according to claim 16 wherein said window breaking implement is arranged on a surface of the device which faces the surface provided for attachment to the flashlight.

20. The device according to claim 16 wherein said window breaking implement comprises a point made of hard metal.

21. The device according to claim 16 wherein said window breaking implement is centered on the outside of the device.

22. The device according to claim 16 wherein said striking pin is centrally arranged.

23. The device according to claim 16 comprising a stabiliser coupled to said striking pin.

24. The device according to claim 16 comprising a recess, and a cutting implement disposed in said recess of the device.

25. The device according to claim 16 wherein said cutting implement is disposed in said recess and spaced apart from the external dimensions of the device.

26. The device according to claim 16 wherein said recess is narrower than the width of a finger.

27. The device according to claim 16 wherein said cutting implement comprises two blades directed outwardly.

28. The device according to claim 16 comprising a guide disposed in said recess adjacent to said blades.

29. The device according to claim 16 comprising a shaped mark formed on the device which corresponds to the direction of the blades.

30. A device for coupling to a flashlight having a battery compartment for receiving batteries comprising:
a cap for coupling to the battery compartment,
a window breaking implement slidably disposed in said cap, and having one end extending into the battery compartment of the flashlight for contact with the batteries,
a spring disposed in said cap and urging said breaking implement against the batteries,
a striking pin formed at the other end of said window breaking implement for protrusion out of said cap, so that when said cap is struck against a window surface, the kinetic energy of the batteries in motion overcomes the spring force and moves the breaking implement and striking pin to protrude out of said cap and impact the window surface.
